(19) United States
(12) Patent Application Publication
(10) Pub. No.: US 2011/0202279 A1
(43) Pub. Date: Aug. 18, 2011

(54) METHOD AND SYSTEM FOR TRAIT EVALUATION THROUGH QUANTITATIVE GENOTYPING

(76) Inventor: Hein Van Der Steen, Evesham (GB)

(21) Appl. No.: 12/676,605

(22) PCT Filed: Sep. 5, 2008
(86) PCT No.: PCT/IB2008/002317

§ 371 Date: Apr. 1, 2010

Related U.S. Application Data
(60) Provisional application No. 60/970,310, filed on Sep. 6, 2007.

(51) Int. Cl. G06F 19/00

(52) U.S. Cl. 702/19

(57) ABSTRACT

Method for determining in a mixed population of biological organism percentage of individuals originated from two or more contributing populations by quantitative genotyping of the mixed population or samples thereof, without the need to identify or separate the individuals. Also disclosed are methods of determining the survival rate of individuals, growth rate of individuals, and increase in biomass of each of the contributing populations, and the impact of environmental conditions on the survival or growth or increase in biomass of the contributing populations. Also disclosed are methods to study population dynamics in mixed populations of microbes. In addition methods are disclosed to trace chromosomal segments back to founder populations or individuals.

### FIELD OF THE INVENTION

This invention relates to a system and method for evaluating traits through quantitative genotyping.

### BACKGROUND OF THE INVENTION

In population biology, it is often necessary to study a mixed population which consists of individuals from two or more distinct subpopulations of the same group of biological organisms. Each of the subpopulations has a specific genetic background, and individuals from the subpopulations commingle and co-develop in the mixed population. After a period of time, it is often desired to determine the survival and/or reproduction rate and other phenotypic characteristics (such as growth rate or product quality) of each of the subpopulation or relate the population dynamics to characteristics of the environment they affect.

In the studies of a phenotypic trait of interest, however, it is often very difficult to conduct individual identification and trait recording when a large number of individuals are involved, or when the individuals involved are small, or identification of specific individuals is technically difficult. Examples of these phenotypic trait evaluations include large scale evaluation of performance (e.g. survival rate and growth rate) of different broiler chicken populations; or yield of different corn populations, or deformities, survival rate and growth rate of different shrimp populations, or a quantitative or qualitative trait of microbial strains. These studies may also be conducted to evaluate the subpopulation's performances under different environmental conditions or experimental treatments and/or to evaluate the impact of the mixed population dynamics on the environment that it affects. Another example is content verification, where it is necessary to determine the composition (e.g. the genetic origin) of a population.

The present invention provides a method and a system that avoids the need to conduct individual identification and individual trait recording in the mixed population.

### SUMMARY OF THE INVENTION

The present inventor has surprisingly discovered that by measuring the allele frequency of a gene in a mixed population, various characteristics of the mixed population can be determined. In an embodiment, the present invention provides a method for determining, in a Mixed Population (MP) of a biological organism which consists of individuals originated from p Populations, denoted Population¹, Population^{p-1}, and Population^{p}, wherein p is an integer greater than 1, the percentage of individuals (or contribution, C), originated from each population (C₁, . . . Cₚ). The biological organism should comprise at least (p−1) genetic markers, denoted Marker¹, . . . and Marker^{p-1}, the allele frequency for each of the genetic markers can be determined in the MP and in each of the contributing populations. The allele frequency for Marker¹ in the MP is denoted F¹ₘ, for Marker^{p-1} is denoted F^{p-1}ₘ, and wherein the allele frequency for Marker¹ in Population¹ is F¹₁, for Marker^{p-1} is F^{p-1}₁, and wherein the allele frequency for Marker¹ in Population^{p} is F¹ₚ, for Marker^{p-1} is F^{p-1}ₚ. The method comprises 1) determining the values of allele frequency for each of the Markers¹ to Markers^{p-1} in the MP (F¹ₘ to F^{p-1}ₘ) via sampling and quantitative genotyping in pooled samples, 2) determining the values of allele frequency for each of the Markers (Marker¹ to Marker^{p-1}) in each population contributing to the MP (Population¹ to Population^{p}): F¹₁, F¹₂ . . . F^{p-1}ₚ₋₁, and F^{p-1}ₚ, 3) calculating the fraction of the number of individuals in the MP originated from each of the contributing populations (C₁ to Cₚ) by solving the following set of equations:

$${F}_{m}^{1} = {C}_{1} \cdot {F}_{1}^{1} + {C}_{2} \cdot {F}_{2}^{1} + … + {C}_{p} \cdot {F}_{p}^{1}$$

$${F}_{m}^{2} = {C}_{1} \cdot {F}_{1}^{2} + {C}_{2} \cdot {F}_{2}^{2} + … + {C}_{p} \cdot {F}_{p}^{2}$$

$$…$$

$${F}_{m}^{p - 1} = {C}_{1} \cdot {F}_{1}^{p - 1} + {C}_{2} \cdot {F}_{2}^{p - 1} + … + {C}_{p} \cdot {F}_{p}^{p - 1} , \\ and$$

$${C}_{1} + {C}_{2} + … {C}_{p} = 1$$

In certain embodiments, p is 2, or is greater than two.

In certain embodiments, the number of markers is p−1, or greater than p−1.

The biological organism may be an animal, such as farm animal, livestock such as chicken, farmed fish, or shrimp, or a plant, especially a crop plant, such as corn, wheat, soybean, or a microbe, such as virus, bacterium, yeast, algae, or filamentous fungus.

Based on the percentage, or fraction of individuals in the MP originated from each of the p Populations, the present invention further provides a method for determining the number of individuals in the MP by further determining the total number of individuals in the Mixed Population, and calculating the number of individuals in the mixed Population that are originated from each of the p Populations.

In certain embodiments, the present invention further provides a method for determining, the survival or reproduction rate of individuals from each of the p Populations in the MP, by determining the number of individuals in each of the p Populations prior to the predetermined period of time, and the number of individuals originated from each of the p Populations in the Mixed Population after the predetermined period of time as described above, and calculating the survival rate or reproduction rate of individuals from each of the p Populations based on the above results. The survival/reproduction rate is defined as (the number of individuals originated from each of the p Populations in the Mixed Population after the predetermined period of time)/(the number of individuals in each of the p Populations prior to the predetermined period of time).

In additional embodiments, the present invention provides a method for determining, in a Mixed Population of a biological organism which consists of individuals originated from p Populations, an average growth rate of individuals originated from each of the p Populations, the method comprising, 1) determining number of individuals from each of the p Populations in the MP as described above, 2) collecting a sample of the MP, separating the sample into a first sub-sample in which the weight of individuals are approximately above a medium value, and a second sub-sample in which the weight of individuals are approximately below the medium value; wherein the first and second sub-samples have approximately the same number of individuals, and determining the total weight of each of the sub-samples and the average individual weight of each sub-sample; 3) determining the number of individuals in the first sub-sample that are originated from each of the p Populations according to a method, 4) determining the number of individuals in the second sub-sample that are originated from each of the p Populations, 5) calculating the average individual weight and the total weight of individuals in the first sub-sample, and the average individual weight and the total weight of individuals in the second sub-sample; and 6) calculating the average individual weight in the Mixed Population from each of the p Populations. In specific embodiments, step (2) of the above method of measuring average growth rate comprises (a) collecting a sample of the MP, and measuring the weight of each individual in the sample, and determining a medium value of the individual weight; (b) dividing the sample of the MP into a first sub-sample in which the weight of all individuals are above the medium value, and a second sub-sample in which the weight of all individuals are below the medium value.

In another embodiment, the present invention provides a method for determining, in a Mixed Population (MP) of a biological organism which consists of individuals originated from p Populations, the effect of Environmental Condition 1 (EC1) and Environmental Condition 2 (EC2) on survival rate of individuals originated from each of p Populations, wherein the individuals from each of the p Populations are commingled in the MP and allowed to grow for a predetermined period of time, the method comprising: 1) providing a Mixed Population and dividing the MP into a first half and a second half, 2) allowing the first half of the MP to grow under EC1 and the second half under EC2 for the predetermined period of time, and 3) calculating the survival rate of individuals originating from each of the p Populations in the first half of the MP and in the second half of the MP as described above.

In another embodiment, a method is provided for determining in a MP the effect of Environmental Condition 1 (EC1) and Environmental Condition 2 (EC2) on growth rate of individuals originated from each of the contributing populations, wherein the individuals from each of the contributing populations are commingled in the MP and allowed to grow for a predetermined period of time. Specifically, the method comprises 1) providing a Mixed Population and dividing the MP into a first half and a second half, 2) allowing the first half of the MP to grow under EC1 and the second half under EC2 for the predetermined period of time, and 3) calculating the growth rate of individuals originating from each of the p Populations in the first half of the MP and in the second half of the MP as described above. The growth rates for the p Populations under EC1 and under EC2 may be compared to evaluate the impact of the environments.

In another embodiment, the present invention also provides a method for determining the contribution from each of the p Populations to a MP consisting of progeny of the p Populations.

The inventive method of the present invention may also be adapted to measure the increase in biomass of each of p Populations in the MP, wherein the individuals from each of the p Populations are commingled in the MP and allowed to grow for a predetermined period of time, without the need for the identification or measurement of the individuals. A method of the invention comprises: 1) determining the average individual growth of each of the p Populations in the MP as described above; 2) calculating the number of individuals in each of the p Populations that survived in the MP based on the survival rate and total number of individuals in each of the p Populations prior to the predetermined period of time; and 3) calculating the increase in biomass of each of the p Populations by multiplying the individual growth with the total number of survived individuals for each of the p Populations. The present invention further provides a method for comparing the effect of Environmental Conditions 1 (EC1) and Environmental Condition 2 on the increase in biomass of each of p Populations in the MP, wherein the individuals from each of the p Populations are commingled in the MP and allowed to grow for a predetermined period of time, the method comprising 1) providing a Mixed Population and dividing the MP into a first half and a second half, 2) allowing the first half of the MP to grow under EC1 and the second half under EC2 for the predetermined period of time, 3) calculating the increase in biomass for each of the p Populations in the first half of the MP and in the second half of the MP as described above, and 4) comparing the increase in biomass for each of the p Populations grown under EC1 and under EC2.

### BRIEF DESCRIPTION OF THE DRAWINGS

Other objects, advantages and novel features of the present invention will become apparent from the following detailed description when considered in conjunction with the accompanying drawings.

FIG. 1 is a block, diagram summarizing the generalized technical concept of the present invention involving a Mixed Population consisting of p contributing populations and trait recording based on dividing the Mixed Population into n phenotype classes.

FIG. 2 is a block diagram summarizing the application of method of the invention to measuring the impact of different environmental conditions on individuals originated from p different contributing Populations in the Mixed Population, which is divided into two subpopulations, Mixed Population A and Mixed Population B, each of which is divided into n phenotype classes.

FIG. 3 is a graphical representation of the data in Table 10.

FIG. 4 illustrates the impact of trait distribution on definition of phenotype classes.

FIG. 5 shows the contribution to certain chromosomal segments from one of two founders to a set of selected inbred lines, from F1 to F7, with selection of the most superior lines after each generation. It illustrates that stepwise selection of the most superior lines results in the accumulation of favorable chromosome segments from the founders.

FIG. 6 shows the contribution to certain chromosomal segments from 4 founders to a group of superior F8 plants. It illustrates that each founder contributes certain favorable chromosomal sections to the most superior plants in generation F8.

FIG. 7 shows allele frequency distribution pattern of a product (y-axis) and of a line (x-axis) that contributes 25% (top left panel), 50%, 75% or 100%) to the product. It is apparent that the pattern depends on the % contribution of the line. The resolution can be further improved by the use of pairs of linked markers.

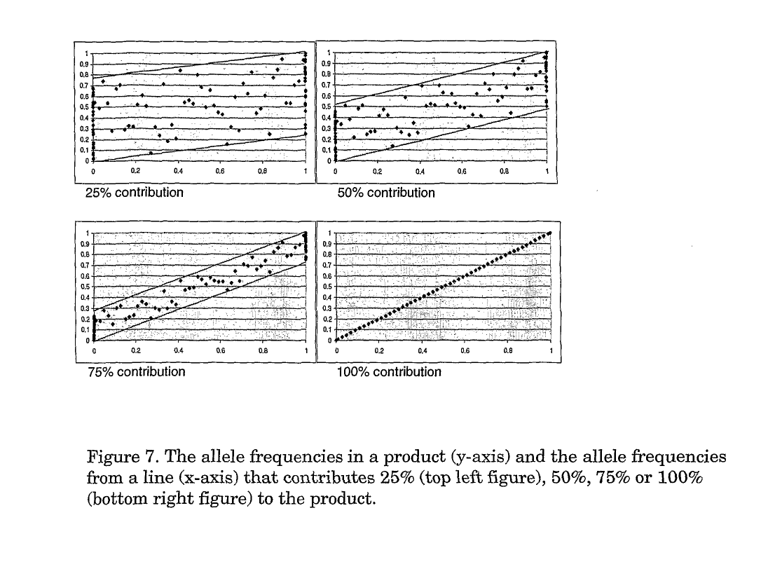

FIG. 8 shows the development over time of a microbial mix consisting of 10 different strains. It is clear that different strains have different development patterns that might be related to their function in the system.

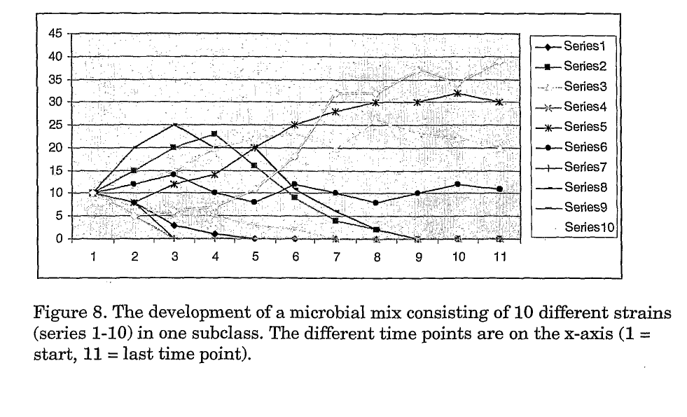

FIG. 9 shows that above certain threshold, sample size increases does not significantly decrease coefficient of variation (CV). Specifically, it summarizes the results for total population N=12,500 and N=25,000 with 8 families involved. Multiples of 250 shrimps are sampled. For N=12,500, 1-50 times 250 shrimp are sampled, and for N=25,000, 1-100 times 250 shrimp are sampled. The CV is the coefficient of variation for the 8 families, averaged over 40 simulation replicates.

FIG. 10 illustrates the impact of sample size on the CV for different number of families.

FIG. 11 illustrates the impact of sample size per family on the CV.

### DESCRIPTION OF PREFERRED EMBODIMENTS

Technical Concept

1. Determination of Contribution of Sub-Populations to a Mixed Population

The frequency (Fₘ) of an allele of a polymorphic genetic locus (allele frequency) in a Mixed Population (MP) that consists of two sub-populations (Population 1 and Population 2) will depend on the frequencies of the same allele in Population 1 (F₁) and in Population 2 (F₂), and the contribution and survival of the two populations in the Mixed Population, i.e., the fractions C₁ (fraction of number of individuals in the Mixed Population that originated from Population 1) and C₂ (fraction of the number of individuals in the Mixed Population that originated from Population 2):

Fₘ=C₁·F₁+C₂·F₂ (Equation 1)

and

C₁+C₂=1 (Equation 2).

This can be turned around by stating that the contribution of two populations to a mix can be calculated from the allele frequencies in the Mixed Population and the allele frequencies in the two populations. So,

Fₘ=(1−C₂)·F₁+C₂·F₂, and

C₂=(F₁−Fₘ)/(F₁−F₂), and

C₁=1−C₂ (Equation 3)

Stated another way, by measuring the allele frequency in the 2 starting populations, and the allele frequency of the same allele in the Mixed Population, the contributions of Populations 1 and 2 in the Mixed Population can be calculated.

For instance, if Fₘ=0.44, F₁=0.60 and F₂=0.40, then

C₂=(0.60−0.44)/(0.60−0.40)=0.80 and C₁=0.20.

Thus, if the allele frequency in the 2 populations is 0.60 and 0.40 while it is 0.44 in the mix, we can calculate from that, that the contributions of populations 1 and 2 in the mix are 20 and 80%, respectively.

In this example, one marker is the minimum to obtain an estimate of the contributions. However, it is readily recognized by those skilled in the art that more than one marker can be used to increase the accuracy of the estimates. Furthermore, for certain applications it will be necessary to subdivide the Mixed Population into sub-classes and calculate the contribution of Populations 1 and 2 in each of the sub-classes.

In situations where the Mixed Population consists of more than 2 sub-populations, more than one marker is needed for making the determination of the contributions. In principle, the minimum number of markers needed will be equal to the number of sub-populations minus 1.

2. Determination, of Performance of Individuals from Subpopulations in a Mixed Population

One can take advantage of the above technical concept to measure a quantitative or qualitative phenotype of individuals in a mixed population, provided that the individuals of the Mixed Population, or a sample thereof, can be approximately divided into two or more groups based on a visual or other assessment.

For example, if weight is the phenotype of concern, in a MP that comprises individuals from P1 and P2, the individuals may be approximately divided into two categories, High Weight Individuals (HW) or Low Weight Individuals (LW). As will be explained below, the division of the individuals into the HW and LW group does not have to be precise and will only have a minor impact on the accuracy of the estimation of the individual performance at issue.

The allele frequency of P1 is known or was measured before commingling as F₁, and the allele frequency of P2 is known or was measured before commingling as F₂. Similarly, the allele frequency in HW can be measured by quantitative genotyping and is F_{HW}, and the allele frequency of LW is F_{LW}. From these, we have:

contribution of P2 Individuals to LW subgroup C_{2LW}=(F₁−F_{LW})/(F₁−F₂),

contribution of P1 Individuals to LW subgroup C_{1LW}=1−C_{2LW},

contribution of P2 Individuals to HW subgroup C_{2HW}=(F₁−F_{HW})/(F₁−F₂),

and contribution of P1 Individuals to HW subgroup C_{1HW}=1−C_{2HW}.

After a predetermined period of growth, a sample is taken of the MP, and the individuals from the sample are approximately divided into the HW and LW subgroups. For each of the HW and LW, the total number of individuals sampled, N_{HW} and N_{LW}, respectively, is known, and the total weight of the sample, W_{HW} and W_{LW}, is also measured. Then the average individual weight of the sample and consequently of the MP can be estimated as

average individual weight of the MP=(W_{HW}+W_{LW})/(N_{HW}+N_{LW}).

average individual weight for the LW subgroup=W_{LW}/N_{LW}

average individual weight for the HW subgroup=W_{HW}/N_{HW}

The total weight, W_{MP}, of all individuals of MP is measured. Thus, the total number of individuals in the MP is calculated as:

N_{MP}=W_{MP}/(average individual weight of the MP).

The number of LW individuals in the MP originated from P1 is

N_{1LW}=N_{MP}·C_{1LW}·N_{LW}/(N_{LW}+N_{HW})

while the number of HW individuals in the MP originated from P1 is

N_{1HW}=N_{MP}·C_{1HW}·N_{HW}/(N_{LW}+N_{HW})

and the total number of individuals in the MP originated from P1 is

N₁=N_{1LW}+N_{1HW},

Similarly, the total number of individuals in the MP originated from P2 is N₂=N_{2LW}+N_{2HW}.

From these, the average individual weight in the MP of individuals originated from P1 is calculated as:

(total weight of individuals from P1)/(total number individuals from P1)=[(average individual weight W for the LW subgroup)·N_{1LW}+(average individual weight W for the HW subgroup)·N_{1HW}]/N₁, and

the average weight of individuals in the MP that originated from P2 as

(total weight of individuals from P2)/(total number individuals from P2)=[(average individual weight W for the LW subgroup)·N_{2LW}+(average individual weight W for the HW subgroup)·N_{2HW}]/N₂.

From the above, and assuming the individual weight in the P1 and P2 prior to the predetermined period of growth is measured or otherwise known, the average individual growth (weight gain) in P1 and P2 can be calculated.

Assuming that N₁ₒ, the original total number of individuals of P1, and N₂ₒ, the original total number of individuals of P2, are also known, then:

the survival rate of individuals from P1 in the MP is N₁/N₁ₒ

the survival rate of individuals from P2 in the MP is N₂/N₂ₒ

3. Determination of Performance of Subpopulations in a Mixed Population Under Different Environmental Conditions

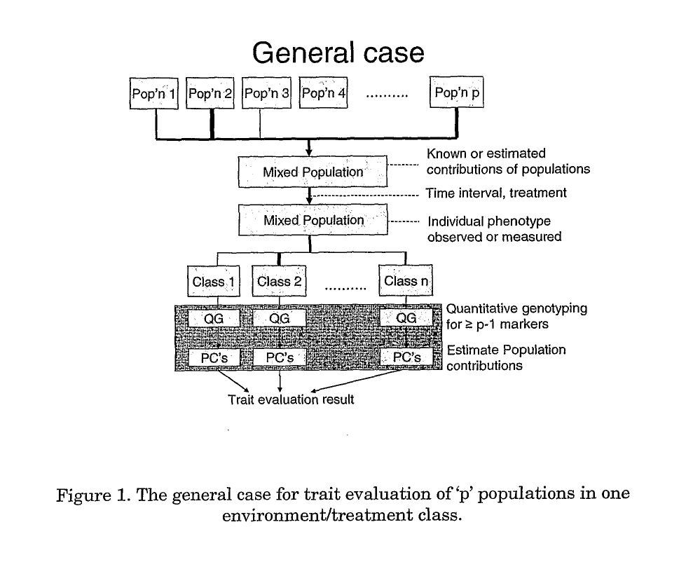

The above technical concept can be generalized to a Mixed Population consisting of p contributing populations and n phenotype classes. This is illustrated in FIG. 1.

As shown in FIG. 1, the MP will have ‘p’ contributing populations of unidentified individuals of a biological organism. From each population the allele frequency for each of a number of markers is known or can be measured via quantitative or individual genotyping. The number of populations ‘p’ can be 2 or more, and the number of markers is p−1 or more.

The frequency (F¹ₘ) of an allele of the first marker in the Mixed Population will depend on the frequencies of the same allele in each of the subpopulations (F¹₁ to F¹p), and the contributions of the populations in the Mixed Population, i.e., the fractions C₁ (fraction of number of individuals in the Mixed Population that originated from Population 1) to Cₚ (fraction of the number of individuals in the Mixed Population that originated from Population p):

$$\begin{matrix}{F}_{m}^{1} = {C}_{1} \cdot {F}_{1}^{1} + {C}_{2} \cdot {F}_{2}^{1} + … + {C}_{p} \cdot {F}_{p}^{1} & ( Equation 4.1 ) \\ {F}_{m}^{2} = {C}_{1} \cdot {F}_{1}^{2} + {C}_{2} \cdot {F}_{2}^{2} + … + {C}_{p} \cdot {F}_{p}^{2} \\ … & ( Equation 4.2 ) \\ {F}_{m}^{p - 1} = {C}_{1} \cdot {F}_{1}^{p - 1} + {C}_{2} \cdot {F}_{2}^{p - 1} + … + {C}_{p} \cdot {F}_{p}^{p - 1} \\ And & ( Equation 4. p \text{-} 1 ) \\ {C}_{1} + {C}_{2} + … + {C}_{p} = 1 & ( Equation 4. p )\end{matrix}$$

The p equations with p unknowns can be solved to obtain the values of C₁ to Cₚ.

With >p markers, the >p equations with p unknowns can be solved with mixed model statistical technology to obtain the values of C₁ to Cₚ.

Each of these subpopulations contributes a certain number of individuals to the Mixed Population at the start. The contributions can be equal or unequal. If unequal, the contributions can be known or estimated.

After a certain time period, the MP can be sampled (or all individuals used) and the sampled individuals can be allocated to ‘n’ classes based on an observable (e.g. visual) or measured phenotype. The number of classes ‘n’ can be 1 or more.

Based on an embodiment of the present invention, the contribution of the different populations to each of the classes can be calculated from the allele frequencies of the contributing populations for all markers in the population and the allele frequency in each class for all of the markers. The results of the different classes can be combined and used to derive information about the populations.

For example, if the contributions at the start are unequal and not known, we can use the invention to estimate these contributions from the different populations.

The time interval can be for example the interval between start and end of a specific growth/development stage of interest or the interval between start and end of a treatment.

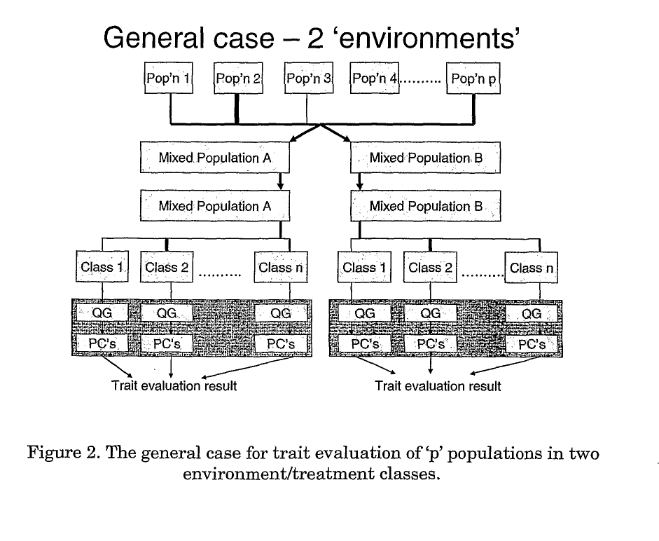

The MP can be divided into two or more batches, each of which undergoes a different treatment or is exposed to a different set of environmental conditions. The inventive method illustrated in FIG. 1 can be used for each treatment and/or environment. This is illustrated in FIG. 2.

When assaying the allele frequencies, the MP sample is divided into a plurality of classes, which can be based on quantitative traits such as weight, length or number of leaves or qualitative traits such as a quality score or a certain abnormality.

The generalized concept is further illustrated below using an example with 5 contributing shrimp populations and a trait split into 3 phenotype classes. The MP is tested in two different environments A and B. Four (4) markers are used.

The allele frequencies of the 5 populations for the 4 markers are known. This information makes up the M-matrix in Table 1.

TABLE 1
Allele Frequencies of Starting Populations for Four Markers

| | Population | | | | |
|---|---|---|---|---|---|
| Mᵢⱼ | 1 | 2 | 3 | 4 | 5 |
| Allele frequency marker 1 | 0.1 | 0.9 | 1 | 0.1 | 0.2 |
| Allele frequency marker 2 | 0.8 | 0.9 | 0.2 | 0.8 | 0.2 |
| Allele frequency marker 3 | 0.7 | 0.8 | 0 | 0.1 | 0.9 |
| Allele frequency marker 4 | 0.9 | 0 | 0.8 | 0.2 | 0 |

An equal number (50,000) of individuals from each of the 5 populations are mixed to constitute a MP of 250,000 unidentified individuals. The total weight of the 50,000 individuals for each population is measured, and the average individual weight for each of the 5 populations are calculated and listed in Table 2.

TABLE 2
Average Starting Individual Weight of 5 Populations

| | Population | | | | | |
|---|---|---|---|---|---|---|
| | 1 | 2 | 3 | 4 | 5 | Total |
| Number at start | 50,000 | 50,000 | 50,000 | 50,000 | 50,000 | 250,000 |
| Total Sample Weight (g) | 40,000 | 50,000 | 50,000 | 60,000 | 50,000 | 250,000 |
| Starting Average | 0.8 | 1.0 | 1.0 | 1.2 | 1.0 | 1.0 |
| Individual Weight (g) | | | | | | |

The total MP is split into two equal parts and tested in two environments A and B. At the end of the specified time period a random sample of 2,275 shrimp is taken from each of the two environments, with each sample being split into three approximate weight classes: low, medium and high. The number of individuals and the total weight of the three weight classes is measured. From this we calculate the average individual weight in the three classes.

TABLE 3
Sample data at end of time period for shrimp tested in environment A

| | Class 1 | Class 2 | Class 3 | |
|---|---|---|---|---|
| | Low | Medium | High | Total |
| Number of Individuals in | 495 | 990 | 790 | 2275 |
| Class | | | | |
| Total Weight (g) | 6550 | 17500 | 20000 | 44050 |
| Average Individual Weight | 13.23 | 17.68 | 25.32 | 19.36 |
| (g) | | | | |

The allele frequency for each of the four (4) markers in the pooled samples for each of the 3 classes is determined, e.g. through quantitative genotyping. This information is presented in Table 4 as three y-vectors.

TABLE 4
Measured Allele Frequencies (Vector y) in Pooled
Samples for Three Weight Classes

| | Phenotype Class | | |
|---|---|---|---|
| | Class 1 | Class 2 | Class 3 |
| | Low | Medium | High |
| | y₁ | y₂ | y₃ |
| Allele frequency marker 1 | 0.495 | 0.500 | 0.465 |
| Allele frequency marker 2 | 0.620 | 0.580 | 0.540 |
| Allele frequency marker 3 | 0.575 | 0.455 | 0.350 |
| Allele frequency marker 4 | 0.330 | 0.420 | 0.435 |

For the Phenotype Class 1, the vector c₁, the contributions of the 5 populations to class 1, can be calculated using Equation 5:

c₁=(M′M)⁻¹M′y₁ (Equation 5)

Similarly, vectors c₂ and c₃ can be obtained. Vectors c₁, c₂ and c₃ are listed in Table 5 below.

TABLE 5
Contributions of 5 populations to each of three phenotype classes

| | | Population | | | | |
|---|---|---|---|---|---|---|
| | | 1 | 2 | 3 | 4 | 5 |
| Contribution to class 1 | c₁ | 0.20 | 0.30 | 0.15 | 0.15 | 0.20 |
| Contribution to class 2 | c₂ | 0.20 | 0.20 | 0.25 | 0.20 | 0.15 |
| Contribution to class 3 | c₃ | 0.15 | 0.10 | 0.30 | 0.30 | 0.15 |

From the data in Tables 3 and 5 the number of shrimp in the three classes originating from each of the 5 populations can be calculated. The results are listed in Table 6.

The total harvest weight of the entire MP tested in environment A is measured, and is 1,900,000 g. The total number of shrimp of the entire MP is calculated from the average shrimp weight in the samples (19.36 g, Table 3 above). From the total number of harvested shrimp, the overall survival rate is calculated. These are listed in Table 7.

TABLE 6
Estimated number of shrimp per population per phenotype class

| | Population | | | | | |
|---|---|---|---|---|---|---|
| | 1 | 2 | 3 | 4 | 5 | Total |
| Phenotype class 1 | 99 | 148.5 | 74.25 | 74.25 | 99 | 495 |
| Phenotype class 2 | 198 | 198 | 247.5 | 198 | 148.5 | 990 |
| Phenotype class 3 | 118.5 | 79 | 237 | 237 | 118.5 | 790 |
| Total | 415.5 | 425.5 | 558.75 | 509.25 | 366 | 2275 |

TABLE 7
Harvest data

| | |
|---|---|
| Total harvest weight (g) | 1,900,000 |
| # shrimp harvested | 98,127 |
| Overall Survival | 78.50% |

From the number of shrimp in the 3 classes (Table 6) and the average weight of the shrimp in the 3 classes (Table 3), the average weight per population is calculated. Growth equals end weight minus weight at the start. The survival per population can be calculated from the overall survival rate (Table 7), the numbers at the start (Table 2) and the numbers per population in the sample (Table 6). Results are shown in Table 8.

TABLE 8
Estimated harvest weight, growth and survival per population in
environment A.

| | Population | | | | |
|---|---|---|---|---|---|
| | 1 | 2 | 3 | 4 | 5 |
| Average end weight g) | 18.80 | 17.54 | 20.33 | 20.58 | 18.95 |
| Growth (g) | 18.00 | 16.54 | 19.33 | 19.38 | 17.95 |
| Survival % | 71.69% | 73.41% | 96.40% | 87.86% | 63.15% |

The total procedure can be repeated for environment B and results are as given in table 9.

TABLE 9
Estimated harvest weight, growth and survival per population in
environment B.

| | Population | | | | |
|---|---|---|---|---|---|
| | 1 | 2 | 3 | 4 | 5 |
| Average end weight g) | 19.90 | 17.24 | 20.63 | 19.58 | 17.45 |
| Growth (g) | 19.10 | 16.24 | 19.63 | 18.38 | 16.45 |
| Survival % | 73.49% | 75.91% | 90.40% | 82.82% | 66.95% |

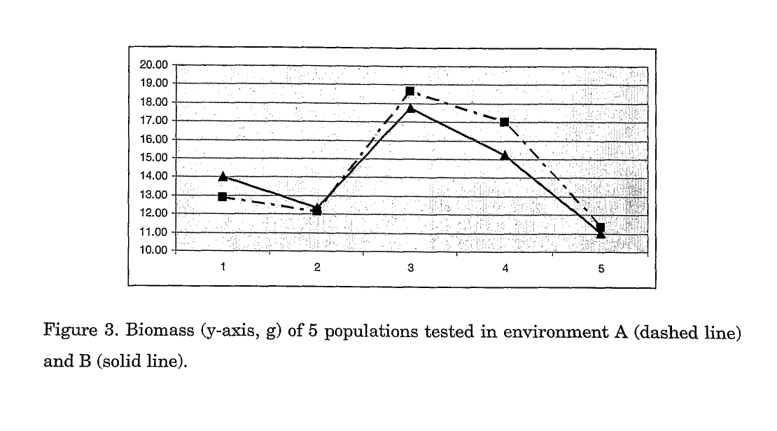

Table 10 shows the above results converted to biomass (growth×survival), which is visualized in FIG. 3. It is apparent that there are consistent population differences across the 2 environments.

TABLE 10
Biomass of 5 populations tested in environment A and B

| | Population | | | | |
|---|---|---|---|---|---|
| | 1 | 2 | 3 | 4 | 5 |
| Biomass environment A | 12.90 | 12.15 | 18.63 | 17.03 | 11.33 |
| Biomass environment B | 14.04 | 12.33 | 17.75 | 15.22 | 11.01 |

A person of ordinary skills in the art would recognize that the above principle is applicable to many specific traits, with appropriate adjustment. Nevertheless, the accuracy of the overall system can be increased through at least the following: using a larger number of markers (e.g. SNPs); using markers (e.g. SNPs) with larger frequency contrast between populations; sampling more animals; increased tissue sample preparation accuracy for DNA extraction; increased numbers of tissue samples per quantitative genotyping test; increased number of replicated DNA extractions per tissue sample; increased number of replicated assays per DNA extract; and improved assay accuracy.

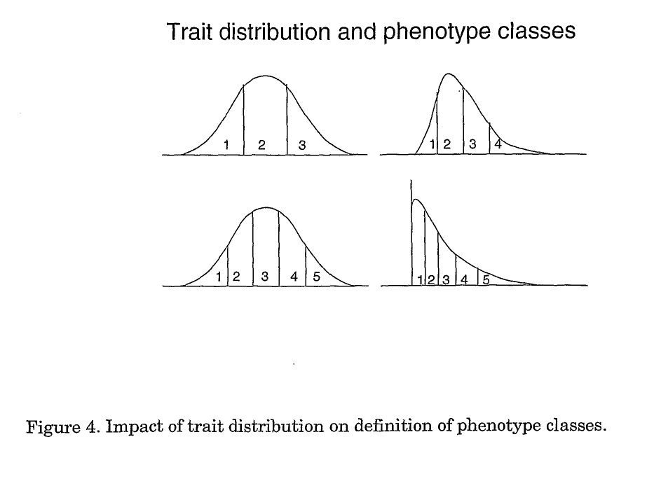

The number of classes depends on the trait of interest and/or the accuracy that needs to be attained. For survival rate, we only need one class, i.e. the survivors. Each sampled individual contributes equally to the pooled tissue sample used for quantitative genotyping. For a qualitative trait, the number of classes is determined by the scoring system. For a quantitative trait, the number and definition of classes need to be determined by the user. The distribution of the trait will have an impact on how to define classes. In general it will be useful to have a class around the mode of the distribution. This leads to defining 3 or more classes. A few examples are given in FIG. 4. In case of a normal distribution we would have an equal number of classes to the left and right of the mode. An increase in the number of classes results in a diminishing increase of the accuracy of the population estimates for the trait of interest. Going from 3 to 5 classes has a bigger impact on accuracy than going from 5 to 7 classes. In case of a skewed distribution, the number of classes should be higher at the tail end of the distribution. From a practical perspective it is attractive to limit the number of classes. From a theoretical perspective it is attractive to increase the number of classes and to increase the homogeneity within classes.

Exemplary Applications

1. Evaluation of Shrimp Performance

Two shrimp populations (products) with a different genetic background are tested for their growth rate and survival rate. A typical commercial grow-out environment is a one-hectare pond with 100-150 shrimp per m². A total of 3 million shrimp need to be tested from the hatched nauplii to the PL12 stage (hatchery performance), from the PL12 to the 2 g stage and then from the 2 g stage to harvest at about 20 g.

At the hatchery two types of shrimp are produced using 2 types of parents, for instance a group of parents selected on growth rate and another group of parents selected on survival rate. For instance 15 spawns for each of the two product types are produced with on average 100,000 nauplii per spawn. The 30 spawns, i.e. 3 million nauplii, are raised in one tank to avoid tank effects. The allele frequencies can be estimated in two ways. First, the parents are genotyped, and an accurate estimate of the number of nauplii per spawn is obtained. From this we calculate the allele frequency for each of the product types and the contribution from both product types to the pool of shrimp to be tested. Alternatively, the spawns of each product type are first pooled in a separate tank, 15 spawns per tank. In each tank the number of nauplii is estimated, and a sample of Nauplii is taken and the allele frequency is estimated through quantitative genotyping. After that the nauplii from both tanks can be put together to avoid common tank effects.

At PL12 stage we estimate the total number of PLs and take a sample for quantitative genotyping. From the allele frequency we calculate the contributions of the 2 product types.

At the 2 g stage we estimate the number of shrimp and take a sample for quantitative genotyping. From the allele frequency we calculate the contributions of the 2 product types.

At harvest we measure total harvest weight and take a sample of shrimp (batch weigh and count) for quantitative genotyping. We can now proceed in two ways. We may use the total sample to measure the allele frequency, and from the allele frequency we calculate the contributions of the 2 product types. From this we calculate survival rate of the 2 products. Alternatively, we may split the sample in half, based on an approximate visual estimate of the shrimp, creating two sub-samples, with about 50% of the shrimp with the higher weight and 50% shrimp with the lower weight, and perform quantitative genotyping for both sub-samples. From the allele frequencies we calculate the contributions of the 2 product types to the high weight and the low weight sample. From this we calculate survival rate and individual weight for the 2 products. The outcome is as follows. We start with 2×15=30 spawns, whose initial measurements are shown in Table 11.

With the known genotypes of the parents and nauplii counts per spawn we calculate the weighted average for the frequency of allele-1 for both product types. Type 1 contributes 47.8% of the 3 million nauplii and has an allele-1 frequency of 79.0%. Type 2 contributes 52.2% of the 3 million nauplii and has an allele-1 frequency of 29.5%.

TABLE 11
Initial Measurements of 30 Spawns

| | # Nauplii | Gen male | Gen fem | Freq 1 | W Freq 1 |
|---|---|---|---|---|---|
| Product 1 | | | | | |
| Spawn | | | | | |
| 1 | 110,000 | 11 | 12 | 0.75 | 0.057 |
| 2 | 90,000 | 11 | 12 | 0.75 | 0.047 |
| 3 | 130,000 | 12 | 11 | 0.75 | 0.068 |
| 4 | 80,000 | 12 | 11 | 0.75 | 0.042 |
| 5 | 75,000 | 11 | 11 | 1.00 | 0.052 |
| 6 | 120,000 | 11 | 12 | 0.75 | 0.063 |
| 7 | 140,000 | 22 | 11 | 0.50 | 0.049 |
| 8 | 80,000 | 11 | 11 | 1.00 | 0.056 |
| 9 | 70,000 | 11 | 22 | 0.50 | 0.024 |
| 10 | 65,000 | 12 | 11 | 0.75 | 0.034 |
| 11 | 90,000 | 11 | 11 | 1.00 | 0.063 |
| 12 | 110,000 | 11 | 12 | 0.75 | 0.057 |
| 13 | 80,000 | 12 | 11 | 0.75 | 0.042 |
| 14 | 75,000 | 11 | 11 | 1.00 | 0.052 |
| 15 | 120,000 | 11 | 11 | 1.00 | 0.084 |
| Total | 1,435,000 | | | 0.800 | 0.790 |
| Product 2 | | | | | |
| Spawn | | | | | |
| 1 | 120,000 | 22 | 12 | 0.25 | 0.019 |
| 2 | 80,000 | 12 | 22 | 0.25 | 0.013 |
| 3 | 150,000 | 22 | 22 | 0.00 | 0.000 |
| 4 | 70,000 | 22 | 12 | 0.25 | 0.011 |
| 5 | 120,000 | 12 | 12 | 0.50 | 0.038 |
| 6 | 90,000 | 11 | 22 | 0.50 | 0.029 |
| 7 | 130,000 | 12 | 11 | 0.75 | 0.062 |
| 8 | 85,000 | 22 | 22 | 0.00 | 0.000 |
| 9 | 95,000 | 22 | 22 | 0.00 | 0.000 |
| 10 | 120,000 | 12 | 12 | 0.50 | 0.038 |
| 11 | 110,000 | 12 | 12 | 0.50 | 0.035 |
| 12 | 130,000 | 22 | 22 | 0.00 | 0.000 |
| 13 | 80,000 | 22 | 22 | 0.00 | 0.000 |
| 14 | 65,000 | 12 | 22 | 0.25 | 0.010 |
| 15 | 120,000 | 12 | 12 | 0.50 | 0.038 |
| Total | 1,565,000 | | | 0.283 | 0.295 |
| Total % | 0.522 | | | | |

Alternatively, we can estimate the allele frequencies based on quantitative genotyping results, from which we can calculate growth and survival for both products. The initial measurements for the two products are shown in Table 12:

TABLE 12
Measurements for the Two Products
Tank 1

| | |
|---|---|
| Estimated number of Nauplii | 1,435,000 |
| Estimated allele frequency | 0.790 |

Tank 2

| | |
|---|---|
| Estimated number of Nauplii | 1,565,000 |
| Estimated allele frequency | 0.295 |
| % Tank 1 | 47.833 |
| % Tank 2 | 52.167 |

Both methods are expected to give the same result, but the first method will be more accurate.

The number of PL12 is estimated to be 1,900,000 and the quantitative genotyping result was 0.47. Table 13 below shows how these results are being used to calculate survival from Nauplii to PL12 stage for both product types.

TABLE 13
Results at the PL12 Stage

| | | | Calculated |
|---|---|---|---|
| | | | from |
| 1 | # At start | 3,000,000 | |
| 2 | # Type 1 | 1,435,000 | |
| 3 | # Type 2 | 1,565,000 | |
| 4 | Contribution type 1 | 0.478 | |
| 5 | Contribution type 2 | 0.522 | |
| 6 | Allele-1 freq type 1 | 0.790 | |
| 7 | Allele-1 freq type 2 | 0.295 | |
| 8 | # estimated at PL12 stage | 1,900,000 | |
| 9 | % Survival | 63.33 | 1, 8 |
| 10 | QG allele-1 freq | 0.47 | |
| 11 | Contribution type 2 | 0.64616 | 6, 7, 10 |
| 12 | Contribution type 1 | 0.35384 | 11 |
| 13 | # PLs type 1 | 672,296 | 8, 12 |
| 14 | # PLs type 2 | 1,227,704 | 8, 11 |
| 15 | % Survival type 1 | 46.85 | 2, 13 |
| 16 | % survival type 2 | 78.45 | 3, 14 |

The first block of 7 figures are known. We can calculate overall survival as 63.33%. With equation 1, we calculate a contribution for type-2 to the PL12 population of 64.6%. From this we can calculate the number of PL12 per product type and the survival rates of 46.85% and 78.45% for product type-1 and 2, respectively.

The number of 2 g shrimp might be difficult to estimate. We can use an estimate if we have one, or use an assumed value. The value to use in this example is 1,500,000 and the quantitative genotyping result was 0.45. Table 14 below shows how these results are being used to calculate survival from PL12 to the 2 g stage for both product types.

TABLE 14

| | | | Calculated from |
|---|---|---|---|
| 1 | # PL12 at start | 1,900,000 | |
| 2 | # type 1 | 672,296 | |
| 3 | # Type 2 | 1,227,704 | |
| 4 | Allele-1 freq type 1 | 0.790 | |
| 5 | Allele-1 freq type 2 | 0.295 | |
| 6 | # estimated at 2g stage | 1,500,000 | |
| 7 | % survival | 78.95 | 1, 6 |
| 8 | QG allele-1 freq | 0.45 | |
| 9 | Contribution type 2 | 0.6865 | 4, 5, 8 |
| 10 | Contribution type 1 | 0.3135 | 9 |
| 11 | # type 1 | 470,196 | 6, 10 |
| 12 | # type 2 | 1,029,804 | 6, 9 |
| 13 | % Survival type 1 | 69.94 | 2, 11 |
| 14 | % Survival type 2 | 83.88 | 3, 12 |
| 15 | Difference | 13.94 | 13, 14 |

The result is not strongly influenced by the accuracy of the estimate for the number of shrimp at the 2 g stage. This is illustrated in Table 15 below.

TABLE 15

| | | | | | | |
|---|---|---|---|---|---|---|
| # Estimated at 2g stage | 1,200,000 | 1,300,000 | 1,400,000 | 1,500,000 | 1,600,000 | 1,700,000 |
| % Survival | 63.16 | 68.42 | 73.68 | 78.95 | 84.21 | 89.47 |
| % Survival type 1 | 67.51 | 73.13 | 78.76 | 84.38 | 90.01 | 95.64 |
| % Survival type 2 | 60.78 | 65.84 | 70.91 | 75.97 | 81.03 | 86.10 |
| Difference | −6.73 | −7.29 | −7.85 | −8.41 | −8.98 | −9.54 |

At this stage we will have more accurate harvest data. Assume the following results: Total harvest weight of 24,000 kg, sample of 5,000 shrimp, sample weight 50% of lowest weight shrimp of 44 kg, sample weight 50% of heaviest shrimp of 54 kg, QG result for low weight batch 0.44 and for high weight batch 0.52.

From this we can obtain the calculations shown in Table 16.

TABLE 16

| | | | Calculated from |
|---|---|---|---|
| 1 | # 2g shrimp at start | 1,500,000 | |
| 2 | # 2g shrimp type 1 | 470,196 | |
| 3 | # 2g shrimp type 2 | 1,029,804 | |
| 4 | # Shrimp sampled | 5,000 | |
| 5 | Weight low (kg) | 44 | |
| 6 | Weight high (kg) | 54 | |
| 7 | Sample weight (kg) | 98 | |
| 8 | Harvest weight (kg) | 24,000 | |
| 9 | Allele-1 freq type 1 | 0.790 | |
| 10 | Allele-1 freq type 2 | 0.295 | |
| 11 | Shrimp weight (g) | 19.6 | 4, 7 |
| 12 | Shrimp weight low (g) | 17.6 | 4, 5 |
| 13 | Shrimp weight high (g) | 21.6 | 4, 6 |
| 14 | # Shrimp harvested | 1,224,490 | 8, 11 |
| 15 | % Survival 2g-harvest | 81.63 | 1, 14 |
| 16 | QG allele-1 freq Low | 0.44 | |
| 17 | QG allele-1 freq High | 0.52 | |
| 18 | QG allele-1 freg | 0.48 | 16, 17 |
| 19 | Contr. type-2 Low | 0.7067 | 9, 10, 16 |
| 20 | Contr. type-1 Low | 0.2933 | 19 |
| 21 | Contr. type-2 High | 0.5452 | 9, 10, 17 |
| 22 | Contr. type-1 High | 0.4548 | 21 |
| 23 | # shrimp type 1, Low | 179,557 | 14, 20 |
| 24 | # shrimp type 2, Low | 432,688 | 14, 19 |
| 25 | # shrimp type 1, High | 278,437 | 14, 22 |
| 26 | # shrimp type 2, High | 333,808 | 14, 21 |
| 27 | # shrimp type 1 | 457,994 | 23, 25 |
| 28 | # shrimp type 2 | 766,496 | 24, 26 |
| 29 | % Survival type 1 | 97.40 | 2, 27 |
| 30 | % Survival type 2 | 74.43 | 3, 28 |
| 31 | Weight type 1 | 20.03 | 12, 13, 23, 25, 27 |
| 32 | Weight type 2 | 19.34 | 12, 13, 24, 26, 28 |

The summary of results is shown in Table 17.

TABLE 17

| | Type 1 | Type 2 |
|---|---|---|
| # Nauplii | 1,435,000 | 1,565,000 |
| # PL12s | 672,296 | 1,227,704 |
| # 2g shrimp | 470,196 | 1,029,804 |
| # shrimp at harvest | 457,994 | 766,496 |
| Survival Nauplii - PL12 | 46.85 | 78.45 |
| Survival PL12 - 2g | 69.94 | 83.88 |
| Survival 2 g - harvest | 97.40 | 74.43 |
| Survival PL12 - harvest | 68.12 | 62.43 |
| Harvest weight | 20.03 | 19.34 |

To estimate harvest weight, we can increase the accuracy by defining more groups than just the 50% high and low weight bands. We could for instance split the shrimp based on weight into 5 bands (low, medium low, medium, medium high, high). If we would be interested in for instance color, we would separate the shrimp into the different color code classes.

2) Large Scale Evaluation of Broiler Chicken Performance

This example involves the comparison of two broiler chicken products 1 and 2 that we want to test for growth rate and survival in two different commercial environments A and B. In each environment and with each product type we want to test ˜50,000 birds, ˜200,000 in total. An outline of the steps includes:
production of ˜100,000 1 day-old chicks per product type;
take tissue samples of 1) randomly selected parents, or all parents and create four pools (males type 1, females type 1, males type 2, females type) or 2) randomly selected d−1 old chicks and create two pools (type 1 and type 2);
commingle the two products for testing in the two environments A and B;
apply normal commercial husbandry;
at harvest or at the processing line, split the birds into a high and a low weight group;
take a tissue sample of each bird at the slaughter line;
create four tissue pools (high and low weight group from environments A and B);
record slaughter weight and count the total number of broilers processed from each environment; and
run the QG assays for the different pools to estimate allele frequencies (QG result).

An exemplary set of data from the above is shown in Table 18 below. The cursive bold figures are calculated from the data and quantitative genotyping results.

TABLE 18

| | Type 1 | | Type 2 | |
|---|---|---|---|---|
| Day-1 old | 101,250 | | 99,500 | |
| chicks | | | | |
| QG result | 0.18 | | 0.85 | |
| Environment | A | B | A | B |
| Day-1 old | 55,250 | 46,000 | 48,400 | 51,100 |
| chicks | | | | |
| Environment | A | A | B | B |
| Weight | High | Low | High | Low |
| # birds | 50,250 | 48,400 | 40,100 | 39,600 |
| processed | | | | |
| Average | 2.55 | 2.40 | 2.30 | 1.90 |
| weight (kg) | | | | |
| QG result | 0.600 | 0.483 | 0.540 | 0.580 |
| Contr. | 0.6269 | 0.4520 | 0.5373 | 0.5970 |
| Type 1 | | | | |
| Contr. | 0.3731 | 0.5480 | 0.4627 | 0.4030 |
| Type 2 | | | | |
| # birds | 31,500 | 21,878 | 21,546 | 23,642 |
| type 1 | | | | |
| # birds | 18,750 | 26,522 | 18,554 | 15,958 |
| type 2 | | | | |
| Product | Type 1 | Type 1 | Type 2 | Type 2 |
| Environment | A | B | A | B |
| # birds | 53,378 | 45,188 | 45,272 | 34,512 |
| % Survival | 96.61 | 98.23 | 93.54 | 67.54 |
| Weight (kg) | 2.49 | 2.09 | 2.46 | 2.12 |

3) Evaluation of Corn Production

Often inbred lines, crosses, commercial products etc. need to be compared side by side with plants of 2 or more different genotypes commingled and on a large commercial scale. This might involve more than a million plants. Based on the method of the present invention, the following steps can be performed:
i. Select markers with large frequency contrast between genotypes that need to be tested. Parental genotypes are most likely known;
ii. Produce mixed batch of seeds with known (preferably equal) contributions from the test genotypes;
iii. Use normal commercial production procedures; at harvest sample the product. In some cases the total harvest might be used; and
iv. Sample corn kernels which can be grinded into meal and a sub sample can be grinded to a finer level. Several samples can be taken for quantitative genotyping.

The results are shown in Table 19.

The corrected harvest figure is the estimated harvest if only that product would have been used. The results show that Product type 2 is clearly the superior one in this example.

4) Evaluation of Chromosomal Segments of Founder Populations or Founder Plants to New Lines.

Take for example a line development program where one starts with two founder plants or two lines A and B. Most segregation is found in the F2 generation and this is the start of a large number of inbred lines. In each generation the poorest lines are eliminated and after a number of generations one ends up with a small number of superior lines. The question is how the A and B sources contribute to the best lines. To answer this question, samples from the most superior lines are take and the marker allele frequencies are determined, from which the contributions of A and B to the superior lines are estimated.

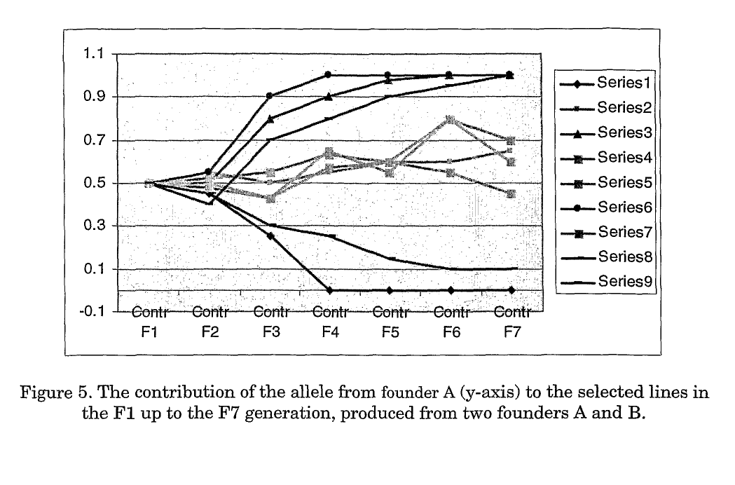

One possible outcome is illustrated in FIG. 5, where each labeled as a series represents one SNP. The y-axis represents the frequency (fraction) of the allele coming from founder A in the subsequent generations. Starting from the F2 stage, some of the poorest lines are culled, and some more poor lines are culled in the F3 generation etc. This will result in an increase of the frequency of the A allele if the allele from founder A is more favorable than the allele coming from founder B. In the example illustrated in FIG. 5, one can see that the A allele of SNPs 3, 6 and 9 and the B allele of SNPs 1 and 8 are favorable and the SNPs 2, 4, 5 and 7 are neutral. Based on this information new F2 lines can be produced and in one step one can select the lines that have the 3 favorable A alleles from founder A and the 2 favorable B alleles from founder B.

Founder A has favorable alleles in the regions around SNPs 6, 3 and 9. Founder B has favorable alleles in the regions around SNPs 1 and 8. We can apply this with a large number of SNPs, genome wide. It would tell us how to do a better job if we would repeat the process. Among the F2's we can now select plants that have most of the favorable regions. Without the present invention, none of the selected lines will have all favorable chromosome segments. With the present invention we can develop new lines that combine all the favorable chromosome segments and we can do it faster.

Another example involves the use of reproduction technology to produce several generations with a short generation interval and without measuring the relevant traits. Assume we start with 4 founder plants. At the F8 stage a large number of plants can be evaluated and information on the relevant trait collected. The contributions of the 4 founder plants can be estimated for thousands of small chromosomal segments across the genome.

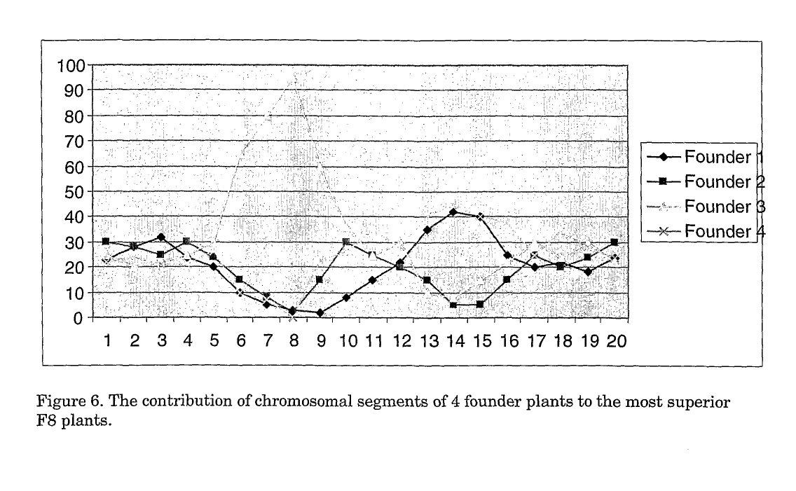

FIG. 6 gives the results of the first 20 chromosomal segments. Founder 3 has something of interest in segments 7-9 while founders 1 and 4 have something of interest in segments 13-15. Specifically, segments 6-9 from founder 3 and segments 13-15 from founders 1 and 4 have a higher than expected frequency among the superior F8 plants. If we do this genome-wide we might identify for instance 12, 7, 14 and 5 sections from founder 1, 2, 3 and 4, respectively that have increased frequency among the most superior F8 plants. This can be due to alleles (haplotypes) that have a favorable impact on the trait of interest or due to chance (false positives). If the experiment is large enough, you can comfortably say that we want to combine the 12+7+14+5=38 identified segments into one line through breeding and selection. We can use this information to produce varieties that combine all favorable chromosomal segments. We can speed up the process by producing double haploids.

5) Shrimp Breeding

In a shrimp breeding program, families (spawn from one sire and dam) need to be tested. Given the spawn size (>100,000 Nauplii), we can test a large number of shrimp per family. This requires tagging or keeping families separate in individual family tanks. Tagging is expensive at large family size while with individual family tanks, a confounding of family and tank effects may interfere with the results. With the present invention we can commingle families, test large families and test them in raceways as well as in ponds.

TABLE 19

| | | | |
|---|---|---|---|
| Product | 1 | 2 | 3 |
| M1 allele freg-1 | 0 | 1 | 0 |
| M2 allele freq-1 | 1 | 0 | 0 |
| Start contribution | 0.335 | 0.332 | 0.333 |
| Marker | M1 | M2 | |
| QG result | 0.528 | 0.283 | |
| Total harvest (Ton) | 200 | | |
| Product | 2 | 1 + 3 | |
| M1 allele freq-1 | 1 | 0 | |
| Contribution | 0.528 | 0.472 | |
| Product | 1 | 2 + 3 | |
| M2 allele freq-1 | 1 | 0 | |
| Contribution | 0.283 | 0.717 | |

| | | |
|---|---|---|
| Harvest | Corrected Harvest | Relative |

| | | | | |
|---|---|---|---|---|
| Contribution 1 | 0.283 | 56.6 | 168.9552 | 0.531 |
| Contribution 2 | 0.528 | 105.6 | 318.0723 | 1.000 |
| Contribution 3 | 0.189 | 37.8 | 113.5135 | 0.357 |

6) Content Verification

In certain situations, a product needs to be evaluated in terms of its genetic makeup, to verify the populations (genetic groups, breeds, lines) that have contributed to the product. This could be for instance, to verify whether a product is for instance traceable to specific lines of one breeding company, or to verify whether a pork product contains 50% genes of a specific line/breed, or to verify whether a proprietary clone has been used for line development by a competitor. Each situation needs a specific approach using the present invention.

The approach will be illustrated with the example of verifying that a pork product contains 50% a specific line. We start with wide scale sampling of the pork product in question. A pooled sample is produced and used for quantitative genotyping, using, for instance, 100 SNPs. We also have a pooled sample of the specific line that contributes 50% of the genes to the product in question. So we end up with 2 pooled samples that are being used for quantitative genotyping. FIG. 5 shows the allele frequencies of the line (x-axis) and the product (y-axis) with 25%, 50%, 75% and 100% contribution of the specific line. It is apparent that the pattern depends on the % contribution of the line. The resolution can be further improved by the use of pairs of linked markers.

7. Microbiological Applications

With microbes such as algae, bacteria and viruses we deal with a large number of small ‘individuals’ that are commingling in certain environments with no link to specific individuals and as such they represent an ideal opportunity to exploit the present invention.

For example, in the study of infectivity of a bacterial pathogen on shrimp, a culture of four Vibrio strains, infectious as well as non-infectious, may be added in equal numbers to a clean (no Vibrio) water system. Shrimp are then added, in order to study the impact of Vibrio infection on the shrimp and the change it causes in the infection level in the water column. The experiment might be carried out with 20 independent replicate tanks. Water samples and shrimp samples would be collected on a regular basis, say 50 times, to study the changes over time. This would result in 2×20×50=2,000 samples. Samples are plated onto medium that supports the growth of the bacteria and colonies counted. As will be recognized by one of ordinary skills in the art, depending on the concentration of bacteria, concentrating using filtration or diluting the sample may be necessary, in either case in order to achieve a count of about 30-300 colonies per plate, each colony representing one living cell (colony forming unit, or CFU) in the original sample. With the present invention we can increase the accuracy and reduce costs. For example, quantitative genotyping is first performed on the 4 vibrio strains to determine allele frequencies for a number of SNPs. We then select a small set of SNPs (3 or more) with large allele frequency differences among the strains. Next step is to perform quantitative genotyping with the small set of SNPs on the 2,000 samples. The information can then be used to calculate the contributions of the 4 species to each of the samples.

An example with viruses would be an experiment where we infect shrimp in a challenge experiment with a mix of three Taura Syndrome Virus (TSV) strains. The objective is to study the virus load in the water column and the shrimp as it develops over time. We collect a large number of water and shrimp samples. First step is to use quantitative genotyping on the 3 TSV strains to determine allele frequencies for a number of SNPs. We then select a small set of SNPs (2 or more) with large allele frequency differences between the TSV strains. Next step is to do the quantitative genotyping with the small set of SNPs on the large number of samples. The information can then be used to calculate the contributions of the 3 strains to each of the samples.

Another example would be an experiment where one evaluates the effectiveness of 40 different strains in certain microbial processes such as fermentation, hydrolysis etc. It is not clear which of these strains are most useful and which combination of strains will do the best job. An expert in the field defines 10 different mixes of microbes that have the potential to be most effective. Each mix contains 10 selected strains. The expert defines the traits of interest of the system. This could be the level of a protein, a fatty acid, a sugar, a flavor compound, a level of degradation, etc. The factors in the experiment are 1) microbial mix (10 different consortia), 2) temperature (10 levels), 3) substrate (5 types) and 4) time point (10 consecutive sampling points). This results in 10×10×5=500 subclasses with 10 microbe samples per subclass. The traits of interest are for instance recorded at the last time point (500 observations). The 5,000 samples are quantitatively genotyped for 20 SNP markers and the results for each sample are used to estimate the contributions of the 10 strains to that sample.

Results for one of the 500 subclasses are given in FIG. 6. Each strain has its own development curve.

The contribution of chromosomal segments of 4 founder plants to the most superior F8 plants. Segment 6-9 from founder 3 and segment 13-15 from founders 1 and 4 have a higher than expected frequency among the superior F8 plants. If we do this genome wide we might identify for instance 12, 7, 14 and 5 sections from founder 1, 2, 3 and 4, respectively that have increased frequency among the most superior F8 plants. This can be due to alleles (haplotypes) that have a favorable impact on the trait of interest or due to chance (false positives). If the experiment is large enough, you can comfortably say that we want to combine the 12+7+14+5=38 identified segments into one line through breeding and selection.

The results can be used to calculate microbial mix parameters. One option is to fit quadratic curves for each strain leading to a regression coefficient for the linear and one for the quadratic component of the curve. So each of the 500 subclasses results in 2 (linear and quadratic)×10 (strains)=20 parameter values that describe the dynamics in the microbial mix over time. The trait of interest (y-variable) can be analyzed with a model that contains the effects of microbial mix, temperature, substrate, the 20 mixed population parameters and interactions. One potential approach is to use stepwise backward regression to eliminate mixed population parameters that are not significant. The results of this experiment can be used to define new microbial mixes that have the potential to give a better result than any of the 10 mixes tested so far.

Statistical and Software Protocols

In general there are two or more genetic groups and 1 or more markers. Data inputs include:
Marker-allele frequencies of ‘p’ genetic groups/populations/families as starting point;
One or more) sample pools, each with a quantitative estimate of the allele frequencies for in markers (m≧p−1).

The objective is to estimate the contributions of the genetic groups to the pool(s). Assume that the SNP genotypes/allele frequencies of the genetic groups are known and that the SNPs are unlinked, then we have a matrix M (dimensions m×p) of SNP allele frequencies. The least squares model for the m×1 vector of observed SNP allele frequencies for one sample pool is y=Mc+e, where c is the p×1 vector of contributions and c can be estimated as (M′M)⁻¹M′y.

Small sampling and/or experimental errors in y can lead to big errors in estimates of c, including negative estimates of contributions. This can be solved by using certain algorithms to find values of c that for instance minimize the sum of squares for error, under the constraint that no element of c should be less than zero, and that the elements of c should add to one. It may require many generations to converge if markers across families are not independent enough.

Another approach is to remove the genetic group with the largest negative contribution (assume contribution is zero) and re-estimate c, and this process is repeated until all remaining estimates are positive.

Accuracy of the System

Accuracy issues will be illustrated with the shrimp example. If we have a certain number of animals (N) of a certain number of genetic groups (p) in a pond and we use QG-ID, the accuracy of the estimated contributions depends on 1) How many shrimp we sample (n); 2) How many samples we draw from the pooled tissue (s); 3) How many replicate measurements per sample we obtain (r); and 4) How many SNP markers we use (m). These are discussed in more detail below.

1) The Number of Shrimp to Sample

The number of shrimp we deal with at sampling depends on the number at stocking and on survival rate. For example, starting with a one hectare pond at a 150 shrimp/m² stocking density, there are 1.5 million shrimp at stocking, and one may end up at harvest with more than 1 million shrimp.

The number of genetic groups (families) in the pond might vary between 2-4 (product evaluation) and 6-12 (family testing). The number of genetic groups will have an impact on the number of shrimp we need to sample.

The first question is what the impact of sample size (n) is in relation to total number of shrimp (N). In a simulation study, N was varied between 1,250 and 25,000. At higher numbers of shrimp (N), the conclusions will not change anymore.

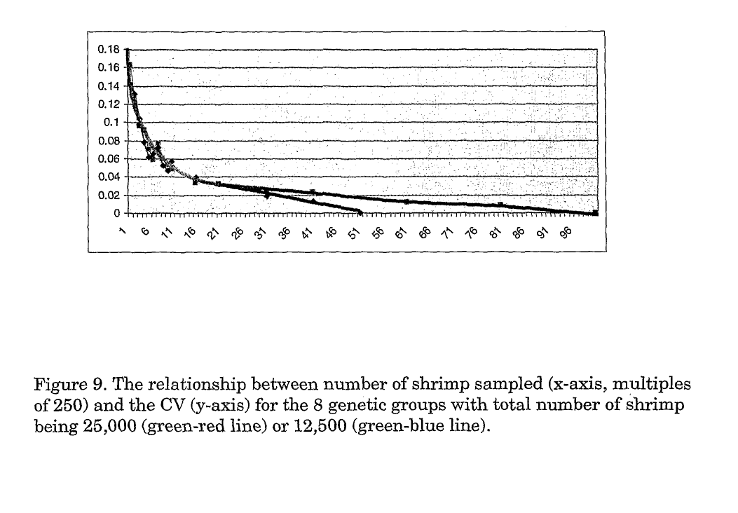

FIG. 9 summarizes the results for N=12,500 and N=25,000 with 8 families involved. We sample multiples of 250 shrimp. For N=12,500 we sample 1-50 times 250 shrimp and for N=25,000 we sample 1-100 times 250 shrimp. The CV is the coefficient of variation for the 8 families, averaged over 40 simulation replicates.

The results show that the relationship is the same for sampling 250 to 5,000 shrimp (green line), independent of having a pond with 12,500 or 25,000 shrimp. With higher numbers in the pond (>25,000), results would be very much the same as those represented by the red line.

The next question is what the impact of the number of families is. To answer this question, simulations were done with N=12,500 shrimp as we are interested in minimum sample size (up to 6,250) and at that level, results do not change if N is larger than 12,500.

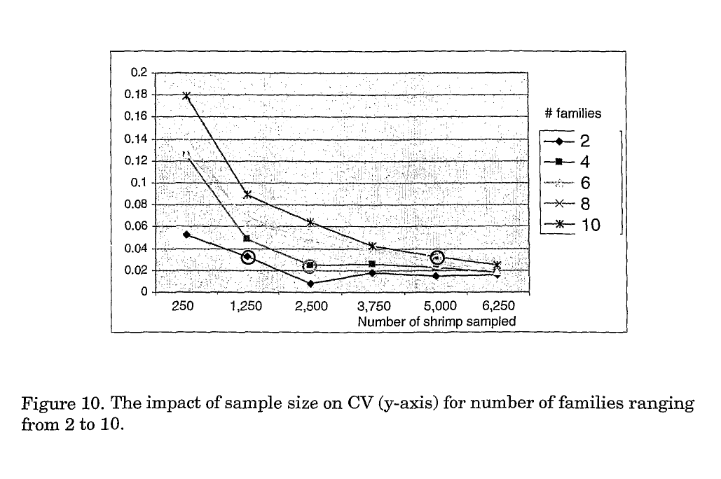

The number of families was 2, 4, 6, 8 or 10. The sample size was 250, 1250, 2500, 3750, 5000 or 6250. Each combination was replicated 40 times. Results are in FIG. 10.

To achieve a CV below 0.04, we need to sample 1250 shrimp if we test 2 families, and 5,000 shrimp if we test 8-10 families.

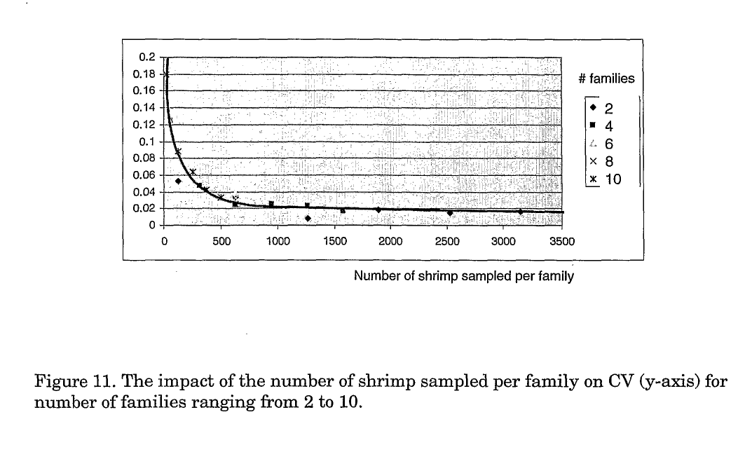

The number of shrimp sampled per family is the driving factor. This is illustrated in FIG. 11. To obtain a CV of 0.02 we need to sample approximately 1000 shrimp per family. To obtain a CV of 0.03 we need to sample approximately 650 shrimp per family.

2. The Number of Samples from Pooled Tissue Sample

Tissue samples from, say, 5000 shrimp, will be put together into one pool that needs to be thoroughly mixed in a large blender. In the ideal case we would only need to take one sample after the mixing process. In reality the mix might not be homogeneous enough and not all shrimp will be properly represented. We have three methods to deal with this lack of homogeneity. We may take sub samples, pool them and continue mixing/grinding in a bender; or we may take several samples from the pool for quantitative genotyping; or a combination of both methods.

The third method is preferable. The procedure needs to be optimized in terms of number of rounds of taking sub samples and further mixing and the number of samples to take in the end for the quantitative genotyping.

3. The Number of Replicate Measurements Per Sample

The measurement of the allele frequency in a sample inherently may have a technical error. If we replicate the measurement a few times, we will observe variation between the measurements. The size of the variance component due to replicated measurement will tell us how many replicates we need.

4. Sample Size and Quantitative Genotyping Method.

Genotype, as is known generally, denotes the genetic constitution of a biological organism, in particular the specific allelic makeup of the individual, usually with reference to a specific genetic locus under consideration. For a diploid genome, a particular genetic locus having two alleles A and B, may be homozygous AA, heterozygous AB, and homozygous BB.

As used in the context of the present invention, genotyping refers to the process of determining the genotype of an individual, for example with a biological assay. Genotyping provides a measurement of the genetic variation between members of a species. Many methods of genotyping are well-known and readily available to those skilled in the art, such as the polymerase chain reaction (PCR) and various thereof, DNA sequencing, and nucleic acid hybridization-based methods including those using microarrays or beads. Single nucleotide polymorphisms (SNP) are the most common type of genetic variation. A SNP is a single base pair mutation at a specific locus, usually consisting of two alleles.

The objective of quantitative genotyping is to establish the frequency of a certain allele in a pooled sample, using different methods such as pyrosequencing, whole genome sequencing (Solexa technology), TaqMan based (q)RT-PCR analyses and melting curve analyses. Each method has its own requirements in terms of sample size and sample preparation. The methods need to be optimized to achieve accurate estimates of the allele frequency in the pool while keeping cost at acceptable level. This will be illustrated with details of one method.

Samples are for instance digested with proteinase K in a lysis buffer overnight and next morning samples are taken for DNA extraction. A larger sample maximizes the chance that genetic groups are properly represented in the digested material.

5. The Number of SNPs to Use

Genotyping might be SNP based, although other methods exists and may be developed. For instance, quantitative genotyping based on whole-genome scanning makes use of sequence tag counts where specific sequences as contributed by individuals from the pool are counted.

The minimum number of SNPs we need is equal to the number of genetic groups (families, populations, breeds, lines, strains) minus 1, i.e. ‘p−1’. A further requirement is that the SNPs have the power to separate the genetic groups. If for instance we have 2 genetic groups and we want to use one marker, the allele frequencies need to be different for both groups. Ideally one group has the 11 genotype and the other group has the 22 genotype.

By using more than ‘p−1’ SNPs we increase the power of the technology. We can maximize the power of the SNP set by using markers that have an allele frequency close to 0.5 across the populations involved.

The foregoing description and examples have been set forth merely to illustrate the invention and are not intended to be limiting. Since modifications of the disclosed embodiments incorporating the spirit and substance of the invention may occur to persons skilled in the art, the invention should be construed broadly to include all variations falling within the scope of the appended claims and equivalents thereof. Furthermore, the teachings and disclosures of all references cited herein are expressly incorporated in their entireties by reference.

1. A method for determining, in a Mixed Population (MP) of a biological organism which consists of individuals originated from p Populations, wherein p is an integer greater than 1, a fraction of number of individuals in the MP originated from each population (C₁, . . . Cₚ),
wherein the p Populations are denoted Population¹, Population², . . . Population^{p-1}, and Population^{p},
wherein the biological organism comprises at least (p−1) genetic markers, denoted Marker¹, Marker², . . . and Marker^{p-1},
wherein an allele frequency for each of the genetic markers is determinable in the MP and in each of the contributing populations, wherein the allele frequency for Marker¹ in the MP is denoted F¹ₘ, for Marker^{p-1} is denoted F^{p-1}ₘ, and wherein the allele frequency for Marker¹ in Population¹ is F¹₁, for Marker^{p-1} is F^{p-1}₁, and wherein the allele frequency for Marker¹ in Population^{p} is F¹ₚ, for Marker^{p-1} is F^{p-1}ₚ,
the method comprising:
1) determining the values of allele frequency for each of the Markers¹ to Markers^{p-1} in the MP: F¹ₘ to F^{p-1}ₘ via sampling and quantitative genotyping in pooled samples,
2) determining the values of allele frequency for each of the Markers (Marker¹ to Marker^{p-1}) in each population contributing to the MP (Population¹ to Population^{p}): F¹₁, F¹₂ . . . F^{p-1}ₚ₋₁, and F^{p-1}ₚ
3) calculating the fraction of the number of individuals in the MP originated from each of the contributing populations (C₁ to Cₚ) by solving the following equations:
$$\begin{matrix}{F}_{m}^{1} = {C}_{1} \cdot {F}_{1}^{1} + {C}_{2} \cdot {F}_{2}^{1} + … + {C}_{p} \cdot {F}_{p}^{1} & ( Equation 4.1 ) \\ {F}_{m}^{2} = {C}_{1} \cdot {F}_{1}^{2} + {C}_{2} \cdot {F}_{2}^{2} + … + {C}_{p} \cdot {F}_{p}^{2} & ( Equation 4.2 ) \\ … & \\ {F}_{m}^{p - 1} = {C}_{1} \cdot {F}_{1}^{p - 1} + {C}_{2} \cdot {F}_{2}^{p - 1} + … + {C}_{p} \cdot {F}_{p}^{p - 1} & ( Equation 4. p \text{-} 1 ) \\ and & \\ {C}_{1} + {C}_{2} + … + {C}_{p} = 1. & ( Equation 4. p )\end{matrix}$$

2. A method for determining the number of individuals in a Mixed Population a Mixed Population (MP) of a biological organism which consists of individuals originated from p Populations, the method comprising
1) determining the fraction of number of individuals originated from each of the p Populations according to claim 1,
2) determining the total number of individuals in the Mixed Population, and
3) calculating the number of individuals in the mixed Population that are originated from each of the p Populations.

3. A method for determining, in a Mixed Population consisting of individuals originated from p Populations, the survival rate of individuals from each of the p Populations, wherein the individuals from each of the p Populations are commingled in the MP and allowed to grow for a predetermined period of time, the method comprising:
1) determining the number of individuals in each of the p Populations prior to the predetermined period of time,
2) determining the number of individuals originated from each of the p Populations in the Mixed Population after the predetermined period of time according to claim 2, and
3) calculating the Survival Rate of individuals from each of the p Populations based on results from steps 1) and 2) above, wherein the survival rate is defined as (the number of individuals originated from each of the p Populations in the Mixed Population after the predetermined period of time)/(the number of individuals in each of the p Populations prior to the predetermined period of time).

4. A method for determining, in a Mixed Population of a biological organism which consists of individuals originated from p Populations, an average growth rate of individuals originated from each of the p Populations, the method comprising
1) determining number of individuals from each of the p Populations in the MP according to claim 2,
2) collecting a sample of the MP, separating the sample into a first sub-sample in which the weight of individuals are approximately above a medium value, and a second sub-sample in which the weight of individuals are approximately below the medium value; wherein the first and second sub-samples have approximately the same number of individuals, and determining the total weight of each of the sub-samples and the average individual weight of each sub-sample;
3) determining the number of individuals in the first sub-sample that are originated from each of the p Populations according to a method,
4) determining the number of individuals in the second sub-sample that are originated from each of the p Populations,
5) calculating the average individual weight and the total weight of individuals in the first sub-sample, and the average individual weight and the total weight of individuals in the second sub-sample; and
6) calculating the average individual weight in the Mixed Population from each of the p Populations.

5. The method of claim 4, wherein step (2) comprises
(a) collecting a sample of the MP, and measuring the weight of each individual in the sample, and determining a medium value of the individual weight; (b) dividing the sample of the MP into a first sub-sample in which the weight of all individuals are above the medium value, and a second sub-sample in which the weight of all individuals are below the medium value.

6. A method for determining, in a Mixed Population (MP) of a biological organism which consists of individuals originated from p Populations, the effect of Environmental Condition 1 (EC1) and Environmental Condition 2 (EC2) on survival rate of individuals originated from each of p Populations, wherein the individuals from each of the p Populations are commingled in the MP and allowed to grow for a predetermined period of time, the method comprising
1) providing a Mixed Population and dividing the MP into a first half and a second half,
2) allowing the first half of the MP to grow under EC1 and the second half under EC2 for the predetermined period of time, and
3) calculating the survival rate of individuals originating from each of the p Populations in the first half of the MP and in the second half of the MP according to claim 3.

7. A method for determining, in a Mixed Population (MP) of a biological organism which consists of individuals originated from p Populations, the effect of Environmental Condition 1 (EC1) and Environmental Condition 2 (EC2) on growth rate of individuals originated from each of p Populations, wherein the individuals from each of the p Populations are commingled in the MP and allowed to grow for a predetermined period of time, the method comprising
1) providing a Mixed Population and dividing the MP into a first half and a second half,
2) allowing the first half of the MP to grow under EC1 and the second half under EC2 for the predetermined period of time,
3) calculating the growth rate of individuals originating from each of the p Populations in the first half of the MP and in the second half of the MP according to claim 4, and
4) comparing the growth rate for each of the p Populations under EC1 and under EC2.

8. A method for measuring, in a Mixed Population (MP) of a biological organism which consists of individuals originated from p Populations, the increase in biomass of each of p Populations, wherein the individuals from each of the p Populations are commingled in the MP and allowed to grow for a predetermined period of time, the method comprising,
1) determining the average individual growth of each of the p Populations in the MP according to claim 4;
2) calculating the number of individuals in each of the p Populations that survived in the MP based on the survival rate and total number of individuals in each of the p Populations prior to the predetermined period of time; and
3) calculating the increase in biomass of each of the p Populations by multiplying the individual growth with the total number of survived individuals for each of the p Populations.

9. A method for comparing, in a Mixed Population (MP) of a biological organism which consists of individuals originated from p Populations, the effect of Environmental Condition 1 (EC1) and Environmental Condition 2 on the increase in biomass of each of p Populations, wherein the individuals from each of the p Populations are commingled in the MP and allowed to grow for a predetermined period of time, the method comprising,
1) providing a Mixed Population and dividing the MP into a first half and a second half,
2) allowing the first half of the MP to grow under EC1 and the second half under EC2 for the predetermined period of time,
3) calculating the increase in biomass for each of the p Populations in the first half of the MP and in the second half of the MP according to claim 8, and
4) comparing the increase in biomass for each of the p Populations grown under EC1 and under EC2.

10. The method according to claim 1, wherein p equals to 2.

11. The method according to claim 1, wherein the biological organism is an animal.

12. The method according to claim 1, wherein the biological organism is a plant.

13. The method according to claim 1, wherein the biological organism is a microbe.
